(19) United States
(12) Patent Application Publication
(10) Pub. No.: US 2023/0209103 A1
(43) Pub. Date: Jun. 29, 2023

(54) INTERACTIVE LIVESTREAMING EXPERIENCE

(71) Applicant: Pinterest, Inc., San Francisco, CA (US)

(72) Inventors: David Temple, Mill Valley, CA (US); Ryan Wilson Probasco, San Leandro, CA (US); Albert Pereta Farre, San Francisco, CA (US); Thorben Primke, San Francisco, CA (US)

(21) Appl. No.: 17/822,772

(22) Filed: Aug. 27, 2022

Related U.S. Application Data
(60) Provisional application No. 63/294,043, filed on Dec. 27, 2021.

(51) Int. Cl. H04N 21/2187; H04N 21/4788

(52) U.S. Cl. CPC H04N 21/2187; H04N 21/4788

(57) ABSTRACT

Described are systems and methods to provide an interactive, livestream platform where multiple participants can connect and engage with a host of an interactive, livestream session and/or other participants engaged in the session. According to exemplary implementations, a live, interactive, livestream session (e.g., by a content creator) can be created among a client device associated with a host and multiple client devices associated with participants/attendees. Further, participants/attendees of the live, interactive, livestream session may request direct interaction and/or engagement with the host of the interactive, livestream session, and a priority can be determined for each participant/attendee based on user history between the participant/attendee and the host, crowd sourced voting of the participants/attendees, access type, and the like.

### CROSS REFERENCE TO PRIOR APPLICATIONS

This application claims the benefit of and priority to U.S. Provisional Patent Application No. 63/294,043, filed on Dec. 27, 2021 and entitled “INTERACTIVE LIVESTREAMING EXPERIENCE,” which is hereby incorporated by reference herein in its entirety.

### BACKGROUND

Creators of content often have difficulty connecting with consumers of their content in intimate settings, as well as monetizing their content. Many creators may not be keen on providing content for payment from certain organizations. While on other platforms, creators may be at the mercy of the systems and algorithms employed by the platforms, and changes in the systems and algorithms may significantly impact and/or affect their ability to connect with consumers of their content and/or consistently monetize their content.

### BRIEF DESCRIPTION OF THE DRAWINGS

FIGS. 1A and 1B are illustrations of exemplary computing environments, according to exemplary embodiments of the present disclosure.

FIGS. 2A-2D are illustrations of exemplary user interfaces that may be presented on client devices of participants, according to exemplary embodiments of the present disclosure.

FIGS. 3A-3D are illustrations of exemplary user interfaces that may be presented on a client device of a host, according to exemplary embodiments of the present disclosure.

FIG. 4 is a flow diagram of an exemplary interactive, video experience creation process, according to exemplary embodiments of the present disclosure.

FIG. 5 is a flow diagram of an exemplary participant engagement process, according to exemplary embodiments of the present disclosure.

FIG. 6 is a flow diagram of an exemplary participant priority determination process, according to exemplary embodiments of the present disclosure.

FIG. 7 is a flow diagram of an exemplary content recommendation process, according to exemplary embodiments of the present disclosure.

FIG. 8 is an illustration of an exemplary client device, according to exemplary embodiments of the present disclosure.

FIG. 9 is an illustration of an exemplary configuration of a client device, such as that illustrated in FIG. 8, according to exemplary embodiments of the present disclosure.

FIG. 10 is an illustration of an exemplary remote computing resource, according to exemplary embodiments of the present disclosure.

### DETAILED DESCRIPTION

Described are systems and methods to provide an interactive, livestream platform where multiple participants can connect and engage with a host of a live, interactive, livestream session and/or other participants engaged in the session in an intimate setting including a relatively few number of participants. According to exemplary implementations, a live, interactive, livestream session (e.g., by a content creator) can be created among a client device associated with a host and multiple client devices associated with participants/attendees. The live, interactive, livestream session can also be associated with a location identifier (e.g., a link, etc.), which can be provided to potential participants of the live, interactive, livestream session. Participants who wish to attend the live, interactive, livestream session can access the live, interactive, livestream session, and confirm details required for attending the live, interactive, livestream session. Once the live, interactive, livestream session is initiated, a user interface presenting a livestream (e.g., video, audio, etc.) of the host may be presented on the client devices associated with the participants/attendees, and a user interface presenting a livestream (e.g., video, audio, etc.) of one or more participants/attendees may be presented on the client device associated with the host.

Exemplary implementations of the present disclosure can also facilitate direct interaction and/or engagement between the participants/attendees and/or between one or more of the participants/attendees and the host during the live, interactive, livestream session. For example, a request may be obtained from one or more of the client devices associated with the participants/attendees of the live, interactive, livestream session representing a desire to interact and/or directly engage with the host of the live, interactive, livestream session. The requests received from the client devices associated with the one or more participants/attendees of the live, interactive, livestream session maybe presented via a user interface presented on the client device associated with the host of the live, interactive, livestream session. In implementations where more than one request is received, embodiments of the present disclosure can determine a priority associated with each participant requesting direct interaction and/or engagement. For example, the priority associated with each participant/attendee may be based on an order in which each participant requested direct interaction and/or engagement with the host, user history between the participant/attendee and the host, crowd sourced voting of the participants/attendees, access type, and the like. Accordingly, the participants/attendees requesting direct interaction and/or engagement with the host may be presented on the client device associated with the host in accordance with the priorities assigned to each participant. The host may then select a participant/attendee, via an interaction with the user interface, to initiate the direct interaction and/or engagement with the participant/attendee.

To facilitate the direct interaction and/or engagement of the participant/attendee and the host, the user interface presented on the client device associated with the host, as well as the client devices associated with the participants/attendees, may be configured to the direct interaction and/or engagement between the chosen participant/attendee and the host. According to certain exemplary implementations, the participant/attendee selected to directly interact and/or engage with the host may be featured prominently on the user interface presented on the client device associated with the host and/or the client devices associated with the participants/attendees.

In an exemplary implementation of the present disclosure, the live, interactive, livestream session may be implemented as a cocktail party, mixer, and/or networking type event. Accordingly, participants/attendees of the live, interactive, livestream session may be grouped (e.g., randomly, pseudo randomly, etc.) for a period of time such that the grouped participants/attendees may directly interact and engage with one another during the period of time. At the expiration of the period of time, the participants/attendees may be re-grouped such that the participants/attendees may directly interact and/or engage with a new group of participants/attendees.

In another exemplary implementation, embodiments of the present disclosure can provide a marketplace for live, interactive, livestream sessions. For example, content creators may list upcoming live, interactive, livestream sessions on a marketplace of live, interactive, livestream sessions where content consumers are able to browse and obtain access to one or more of the listed live, interactive, livestream sessions.

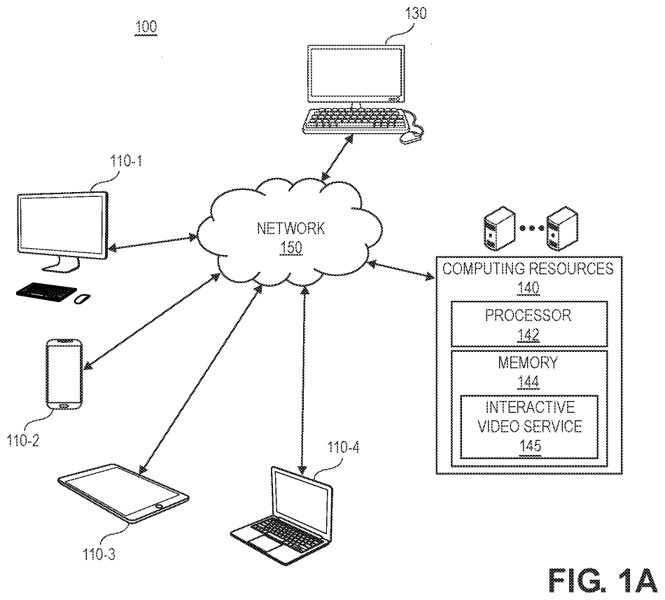

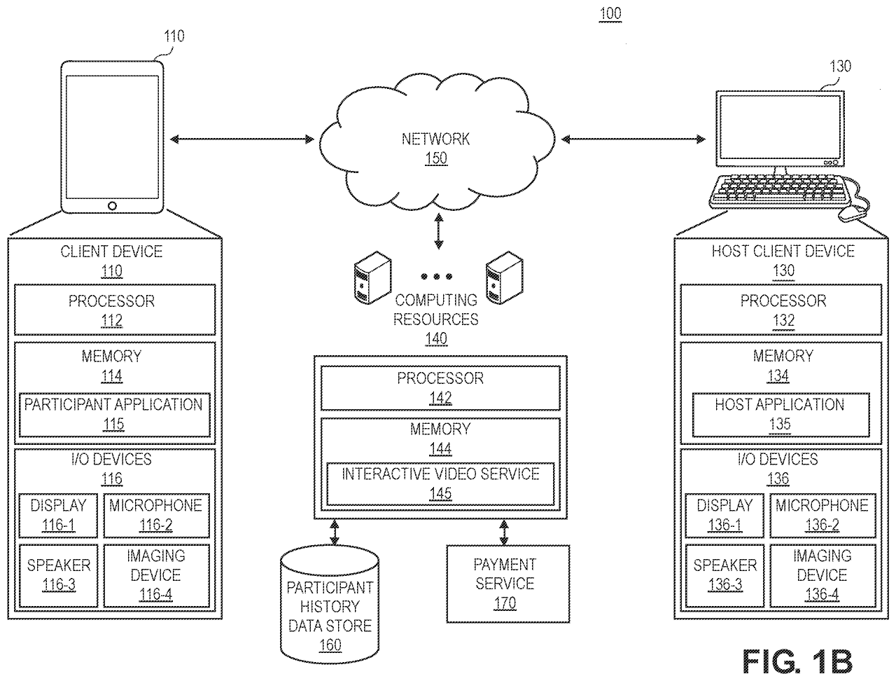

FIGS. 1A and 1B are illustrations of exemplary computing environment 100, according to exemplary embodiments of the present disclosure.

As shown in FIG. 1A, environment 100 may include one or more client devices 110 (e.g., client devices 110-1, 110-2, 110-3, and 110-4), host client device 130, remote computing resources 140, and interactive video service 145, which may execute on remote computing resources 140. Interactive video service 145 may be configured to create and host one or more live, interactive, livestream sessions between client devices 110-1, 110-2, 110-3, and 110-4 and host client device 130. For example, upon a request from a host (e.g., a content creator) via host client device 130, interactive video service 145 may be configured to create and host a live, interactive, livestream session. The host may specify certain parameters associated with the live, interactive, livestream session. For example, the host may indicate the format and/or the content of the live, interactive, livestream session (e.g., a demonstration, a performance, a question and answer session, a discussion on a certain topic, and the like), a maximum number of participants, a cost to access the live, interactive, livestream session, the date and time at which the live, interactive, livestream session may begin, a length of the time for the live, interactive, livestream session, types of access (e.g., attendee, active participant, priority access, etc.) to the live, interactive, livestream session, and the like.

Additionally, in creating the live, interactive, livestream session, interactive video service 145 may also create a session location identifier (e.g., a uniform resource locator “URL”, etc.) that may specify where the live, interactive, livestream session is being hosted by interactive video service 145 and can be accessed. The identifier may be provided in the form of a link to a URL to the host (e.g., via host client device 130), who can be distributed or made available to consumers who may be interested in attending the live, interactive, livestream session. Accordingly, anyone desiring to attend the live, interactive, livestream session may navigate to the location specified by the session location identifier (e.g., selecting a link to a URL using client devices 110-1, 110-2, 110-3, and 110-4, etc.) to register and access the live, interactive, livestream session. Interactive video service 145 may be configured to manage access to, enrollment, payment, etc. to access the live, interactive, livestream session. Once the live, interactive, livestream session has been initiated, interactive video service 145 may determine and manage priorities associated with each participant/attendee, direct interactions and/or engagements between participants/attendees and/or the host, the user interface presented on each client device 110-1, 110-2, 110-3, and 110-4 and host client device 130, and the like.

As shown in FIG. 1A, each of client devices 110 (e.g., client devices 110-1, 110-2, 110-3, and 110-4), host client device 130, and remote computing resources 140 may communicate via wired and/or wireless connections to network 150. Client devices 110 (e.g., client devices 110-1, 110-2, 110-3, and 110-4) and host client device 130 may include any type of computing device, such as a smartphone, tablet, laptop computer, desktop computer, wearable, etc., and network 150 may include any wired or wireless network (e.g., the Internet, cellular, satellite, Bluetooth, Wi-Fi, etc.) that can facilitate communications between client devices 110 (e.g., client devices 110-1, 110-2, 110-3, and 110-4), host client device 130 and remote computing resources 140 (and interactive video service 145 executing thereon). Further, as shown in FIG. 1B, interactive video service 145 may be configured to be in communication with participant history data store 160, and payment service 170. Participant history data store 160 may be configured to store and maintain information associated with one or more of the participants/attendees participating in a live, interactive, livestreaming session. For example, this can include information relating to the participant's history (e.g., level of activity, past events attended, subscription/following status on one or more social media platforms, access type, etc.) in connection with the creator and/or the content created by the creator. Further, payment service 170 may include any payment processing service that can facilitate processing of payment made by participants/attendees to access a live, interactive, livestream session.

According to embodiments of the present disclosure, client devices 110 (e.g., client devices 110-1, 110-2, 110-3, and 110-4) and host client device 130 may access and/or interact with interactive video service 145 through network 150 via one or more applications operating and/or executing on client devices 110 (e.g., client devices 110-1, 110-2, 110-3, and 110-4) and host client device 130 to facilitate initiation and/or performance of a live, interactive, livestreaming session between any of client devices 110 (e.g., client devices 110-1, 110-2, 110-3, and 110-4) and host client device 130.

As shown in FIGS. 1A and 1B, users associated with client devices 110 (e.g., client devices 110-1, 110-2, 110-3, and 110-4) and host client device 130 may launch and/or execute an application on client devices 110 (e.g., client devices 110-1, 110-2, 110-3, and 110-4) and host client device 130 to access and/or interact with interactive video service 145 through network 150. According to aspects of the present disclosure, a user may, via the application on client devices 110 (e.g., client devices 110-1, 110-2, 110-3, and 110-4) and host client device 130, access or log into interactive video service 145 by submitting one or more credentials (e.g., username/password, biometrics, secure token, etc.) through a user interface presented on client devices 110 (e.g., client devices 110-1, 110-2, 110-3, and 110-4) and host client device 130. The credentials provided by the users may be verified by interactive video service 145 and access maybe provided to a live, interactive, livestream between client devices 110 (e.g., client devices 110-1, 110-2, 110-3, and 110-4) and host client device 130.

In one illustrative implementation, after a live, interactive, livestream session has been created, along with a session identifier, a user associated with client device 110 may navigate to the location specified by the session identifier and/or launch or execute an application on client device 110 to access and/or interact with interactive video service 145. Accordingly, via the interaction with interactive video service 145, the user may register for and access the live, interactive, livestream session. The user may provide credentials, a token, and the like, via the application running on client device 110, to access and log into interactive video service 145, process payment for access to the live, interactive, livestream session, and participate in the live, interactive, livestream session. Upon initiation of the live, interactive, livestream session, interactive video service 145 may obtain a video livestream from host client device 130 and one or more of client devices 110 (e.g., client devices 110-1, 110-2, 110-3, and 110-4) and manage the broadcasting of the various livestreams to client devices 110 (e.g., client devices 110-1, 110-2, 110-3, and 110-4) and host client device 130. Further, upon initiation of the live, interactive, livestream session, various input/output devices (e.g., microphones, cameras, etc.) for each of the participants (e.g., on client devices 110-1, 110-2, 110-3, and 110-4) may be automatically disabled, and the participants may not be provided with the ability to change the disabling of such input/output device. The ability to enable and/or disable the input/output devices may only be provided to the host of the live, interactive, livestream session.

According to exemplary implementations, the user interfaces presented on client devices 110 (e.g., client devices 110-1, 110-2, 110-3, and 110-4) and host client device 130 may present the livestream feed of the host and all the participants/attendees simultaneously. Alternatively and/or in addition, the livestream feed of the host may cover a larger area, such that the host is more pronounced and visible, while the participants/attendees are presented as smaller tiles. According to certain aspects, each participant/attendee may be represented by a static object, such as a thumbnail, profile image, or other visual representation and only the livestream of the host may be presented on the user interfaces presented on client devices 110 (e.g., client devices 110-1, 110-2, 110-3, and 110-4) and host client device 130.

Additionally, the live, interactive, livestream session may allow for participants/attendees to request a direct interaction and/or engagement with the host of the live, interactive, livestream session and/or another participant/attendee. For example, the participant/attendee requesting the direct interaction and/or engagement may want to ask a question, engage in a discussion, perform a demonstration, etc. In such a scenario, a user wanting to request direct interaction and/or engagement may interact with a user interface presented on client devices 110 (e.g., client devices 110-1, 110-2, 110-3, and 110-4). Upon interaction with the user interface to indicate that the user is requesting a direct interaction and/or engagement, an indication may be presented and associated with the user on a user interface presented on host client device 130, as well as client devices 110 (e.g., client devices 110-1, 110-2, 110-3, and/or 110-4). Accordingly, the host may select the participant/attendee requesting direct interaction and/or engagement so that the participant/attendee is “brought on stage” with the host. This interaction may be facilitated by modifying the user interface presented on client devices 110 (e.g., client devices 110-1, 110-2, 110-3, and/or 110-4) and host client device 130 to enable a livestream feed of the selected participant/attend and/or highlight and make the selected participant/attendee more prominent. This may be performed, for example, by presenting the host and the selected participant/attendee in a split screen arrangement such that livestream feeds of only the host and the selected participant/attendee are presented on the user interfaces presented on client devices 110 (e.g., client devices 110-1, 110-2, 110-3, and/or 110-4) and host client device 130. Alternatively and/or in addition, a representation of the selected participant/attendee may be increased on the user interface presented on client devices 110 (e.g., client devices 110-1, 110-2, 110-3, and 110-4) and host client device 130, such that the selected participant/attendee is displayed more prominently relative to the other participants/attendees. Additionally, while a livestream feed of the selected participant/attendee is presented, the other participants/attendees may continue to be represented by static objects. Further, during the direct interaction and/or engagement, the input/output devices (e.g., microphones, cameras, etc.) of the participant selected for the direct interaction and/or engagement may be enabled, while the input/output devices (e.g., microphones, cameras, etc.) for each of the other participants may remain disabled so as to not interrupt the direct interaction and/or engagement session. Alternatively and/or in addition, the host and the selected participant/attendee may only be displayed more prominently (e.g., in a split-screen arrangement) on the client devices associated with the host and the selected participant/attendee. The client devices of participants/attendees not engaging in a direct interaction and/or engagement with the host may simply present livestream feeds of the host and the selected participant/attendee (e.g., so they can follow along with the direct interaction and/or engagement) but not in a manner where the selected participant/attendee is presented more prominently.

In implementations where more than one participant/attendee is requesting a direct interaction and/or engagement, interactive video service 145 may determine and manage priorities associated with each participant/attendee (e.g., based on participant history information stored and maintained in participant history data store 160) requesting direct interactions and/or engagements with the host and/or other participants/attendees. For example, an engagement score may be determined for each participant/attendee requesting direct interaction and/or engagement with the host. The engagement score may be an aggregation of the participant's history in connection with the host's content. This may include, for example, whether the participant subscribes to content created by the host, has attended previous sessions, the frequency and amount of purchases, type of access purchased for the session, and the like. Additionally, aspects of the present disclosure may also consider negative user history (e.g., profane/harassing/disruptive behavior in previous sessions, comments left in response to content, and the like) in determining priority and/or blocking specific participants/attendees from directly interacting and/or engaging with the host.

In the example implementation, each participant/attendee requesting direct interaction and/or engagement with the host and/or other participants/attendees may effectuate such a request via an interaction via a user interface presented on his/her respective client device. Accordingly, a user interface presented on host client device 130 may present an indication associated with each participant/attendee requesting direct interaction and/or engagement with the host. According to certain aspects, the user requesting direct interaction and/or engagement with the host may be presented in accordance with the determined priorities associated with each participant/attendee requesting direct interaction and/or engagement with the host. For example, the participant/attendee with the highest priority may be presented first in an ordered list. Alternatively and/or in addition, the priority may be represented using any other means (e.g., visual representation, relative size of the visual object associated with the participant/attendee, relative size or color of the indication representing the request for direct interaction and/or engagement, and the like). Accordingly, the host may select the participant/attendee having the highest associated priority. Further, interactive video service 145 may automatically select the next participant/attendee for direct interaction and/or engagement based on the assigned priorities. For example, the host may simply indicate, via an interaction with the user interface presented on host client device 130, to select the next participant/attendee for direct interaction and/or engagement, and the participant/attendee may be automatically selected based on the assigned priorities.

According to exemplary implementations, the live, interactive, livestream session may also include a chat function, where participants/attendees and/or the host may interact with each other. Additionally, participants/attendees, as well as the host, of the live, interactive, livestream session may be provided with the option to upvote (e.g., like, thumbs up, etc.) and/or downvote (e.g., thumbs down, block, etc.) any comments or questions presented in the chat function. According to certain aspects, the upvote and/or downvotes of comments may also be used by interactive video service 145 in determination of the priorities associated with each participant/attendee in connection with requests for direct interaction and/or engagement, questions to be presented and/or answered by the host, and the like.

According to exemplary implementations of the present disclosure, interactive video service 145 may also provide a marketplace of live, interactive, livestream sessions associated with various hosts. For example, in connection with a request from a host to create a live, interactive, livestream session, the host may be provided with an option to list the session in a marketplace maintained by interactive video service 145. Any live, interactive, livestream sessions selected to be included in the marketplace may be presented with certain parameters associated with the live, interactive, livestream session. For example, the marketplace may present a listing for each live, interactive, livestream session being offered, and may include information such as the name of the host, the format and/or the content of the live, interactive, livestream session (e.g., a demonstration, a question and answer session, a discussion on a certain topic, and the like), a maximum number of participants, a cost to access the live, interactive, livestream session, the date and time at which the live, interactive, livestream session may begin, a length of the time for the live, interactive, livestream session, types of access (e.g., attendee, active participant, priority access, etc.) to the live, interactive, livestream session, and the like. Accordingly, users associated with client devices 110 (e.g., client devices 110-1, 110-2, 110-3, and 110-4) may peruse the listings presented on the marketplace, and may select any of the listed live, interactive, livestream sessions that may be of interest. Similar to described implementations, the user may register for and access the live, interactive, livestream session, via the application running on client device 110, to access and log into interactive video service 145, process payment for access to the live, interactive, livestream session, and participate in the live, interactive, livestream session.

FIG. 1B is a block diagram of an exemplary computing environment, including a client device, a host client device, and remote computing resources executing an interactive video service, according to exemplary embodiments of the present disclosure. The exemplary system shown in FIG. 1A may facilitate a live, interactive, livestream session between client device 110 and host client device 130.

As illustrated, client device 110 may be any portable device such as a tablet, cellular phone, laptop, wearable, etc. Client device 110 may be connected to the network 150 and includes one or more memory 114 or storage components (e.g., a database or another data store), one or more processors 112, and one or more input/output devices 116, including, but not limited to, display 116-1, microphone 116-2, speaker 116-3, imaging device 116-4, etc. Display 116-1 may be any type of display, such as a touch-based display, etc. Imaging device 116-4 may include any form of optical recording sensor or device that may be used to capture, receive, store and/or transmit data, such as video, templates, annotated images, etc. For example, imaging device 116-4 of client device 110 may capture one or more still or moving images. Client device 110 may also connect to or otherwise communicate with the network 150 through the sending and receiving of digital data.

Client device 110 may also include one or more applications, such as participant application 115, stored in memory that may be executed by the one or more processors 112 of client device 110 to cause the processor(s) 112 of client device 110 to perform various functions or actions. For example, when executed, participant application 115 may verify the identity of the user, connect to interactive video service 145, etc. Further, participant application 115 may access display 116-1, microphone 116-2, speaker 116-3, and/or imaging device 116-4 of client device 110 to obtain and transmit a livestream feed from client device 110 to interactive video service 145 and/or host client device 130, as well as obtain and present a livestream feed from host client device 130 (and/or other client devices 110, such as client devices 110-1, 110-2, 110-3 and/or 110-4). In still other examples, interactive video service 145 may provide an interface to enable viewing and/or interaction with a livestream feed received from host client device 130 (and/or other client devices 110, such as client devices 110-1, 110-2, 110-3 and/or 110-4).

Host client device 130 may be any type of device such as a laptop, desktop, dedicated computing device, tablet, etc. In the examples discussed above, and as illustrated in FIG. 1B, host client device 130 is a desktop or laptop computing device. As is known, such devices may include similar components. As such, the components are discussed herein together.

Host client device 130 may include one or more input/output devices 136, including, but not limited to display 136-1, microphone 136-2, speaker 136-3, and/or imaging device 136-4. Display 136-1 may be any type of display, such as a touch-based display, etc. Imaging device 136-4 may include any form of optical recording sensor or device that may be used to photograph, record videos, or otherwise record information or data.

As is shown in FIG. 1B, host client device 130 may be connected to network 150 and may include one or more memory 134 or storage components (e.g., a database or another data store), one or more processors 132, I/O devices 136, and any other components that may be required in order to capture, receive, store and/or transmit data, such as video, templates, annotated images, etc. For example, imaging device 136-4 of host client device 130 may capture one or more still or moving images. Host client device 130 may also connect to or otherwise communicate with network 150 through the sending and receiving of digital data.

Host client device 130 may also include one or more applications, such as host application 135, stored in memory 134, that may be executed by the one or more processors 132 of host client device 130. For example, when executed on host client device 130, host application 135 may verify the identity of the host, connect to interactive video service 145, etc.

Participant application 115 and/or host application 135 may communicate, via network 150, with interactive video service 145 and/or with each other. Generally, interactive video service 145 includes or executes on computing resource(s) 140. Computing resource(s) 140 are separate from client device 110 and from host client device 130. Likewise, computing resource(s) 140 may be configured to communicate over network 150 with client device 110 and from host client device 130, and/or other external computing resources, data stores, such as participant history data store 160, payment service 170, etc.

As illustrated, computing resource(s) 140 may be remote from client device 110 and from host client device 130, and may, in some instances, form a portion of a network-accessible computing platform implemented as a computing infrastructure of processors, storage, software, data access, and so forth that is maintained and accessible by components/devices of interactive video service 145, client device 110, and host client device 130, via network 150, such as an intranet (e.g., local area network), the Internet, etc.

Computing resource(s) 140 do not require end-user knowledge of the physical location and configuration of the system that delivers the services. Common expressions associated with these remote computing resource(s) 140 include “on-demand computing,” “software as a service (SaaS),” “platform computing,” “network-accessible platform,” “cloud services,” “data centers,” and so forth.

Network 150 may be any wired network, wireless network, or combination thereof, and may comprise the Internet in whole or in part. In addition, network 150 may be a personal area network, local area network, wide area network, cable network, satellite network, cellular telephone network, or combination thereof. Network 150 may also be a publicly accessible network of linked networks, possibly operated by various distinct parties, such as the Internet. In some implementations, network 150 may be a private or semi-private network, such as a corporate or university intranet. Network 150 may include one or more wireless networks, such as a Global System for Mobile Communications (GSM) network, a Code Division Multiple Access (CDMA) network, a Long Term Evolution (LTE) network, 5G network, or some other type of wireless network. A variety of protocols and components for communicating via the Internet or any of the other aforementioned types of communication networks may be used with the disclosed implementations.

The computing resources may also include or connect to one or more data stores, such as participant history data store 160, payment service 170, etc. Participant history data store 160 may be configured to store and maintain information relating to participants' history (e.g., level of activity, past events attended, subscription/following status on one or more social media platforms, access type, etc.) in connection with the creator and/or the content created by the creator, and payment service 170 may include any payment processing service that can facilitate processing of payment made by participants/attendees to access a live, interactive, livestream session.

The computers, servers, data stores, devices and the like described herein have the necessary electronics, software, memory, storage, databases, firmware, logic/state machines, microprocessors, communication links, displays or other visual or audio user interfaces, printing devices, and any other input/output interfaces to provide any of the functions or services described herein and/or achieve the results described herein. Also, those of ordinary skill in the pertinent art will recognize that users of such computers, servers, devices and the like may operate a keyboard, keypad, mouse, stylus, touch screen, or other device (not shown) or method to interact with the computers, servers, devices and the like, or to “select” or generate an item, template, annotated image, patient image, and/or any other aspect of the present disclosure.

Interactive video service 145, participant application 115, host application 135, client device 110, and/or host client device 130 may use any web-enabled or Internet applications or features, or any other client-server applications or features including E-mail or other messaging techniques, to connect to network 150, or to communicate with one another, such as, through short or multimedia messaging service (SMS or MMS) text messages. For example, computing resources 140 may be adapted to transmit information or data in the form of synchronous or asynchronous messages from interactive service 145 to client device 110, clinician device 130, or any other computer device in real time or in near-real time, or in one or more offline processes, via network 150.

The data and/or computer executable instructions, programs, firmware, software and the like (also referred to herein as “computer executable” components) described herein may be stored on a computer-readable medium that is within or accessible by computers or computer components, or any other computers or control systems, and having sequences of instructions which, when executed by a processor (e.g., a central processing unit, or “CPU”), cause the processor to perform all or a portion of the functions, services and/or methods described herein. Such computer executable instructions, programs, software and the like may be loaded into the memory of one or more computers using a drive mechanism associated with the computer readable medium, such as a floppy drive, CD-ROM drive, DVD-ROM drive, network interface, or the like, or via external connections.

Some implementations of the systems and methods of the present disclosure may also be provided as a computer-executable program product including a non-transitory machine-readable storage medium having stored thereon instructions (in compressed or uncompressed form) that may be used to program a computer (or other electronic device) to perform processes or methods described herein. The machine-readable storage media of the present disclosure may include, but is not limited to, hard drives, floppy diskettes, optical disks, CD-ROMs, DVDs, ROMs, RAMs, erasable programmable ROMs (“EPROM”), electrically erasable programmable ROMs (“EEPROM”), flash memory, magnetic or optical cards, solid-state memory devices, or other types of media/machine-readable medium that may be suitable for storing electronic instructions. Further, implementations may also be provided as a computer executable program product that includes a transitory machine-readable signal (in compressed or uncompressed form). Examples of machine-readable signals, whether modulated using a carrier or not, may include, but are not limited to, signals that a computer system or machine hosting or running a computer program can be configured to access, or include signals that may be downloaded through the Internet or other networks.

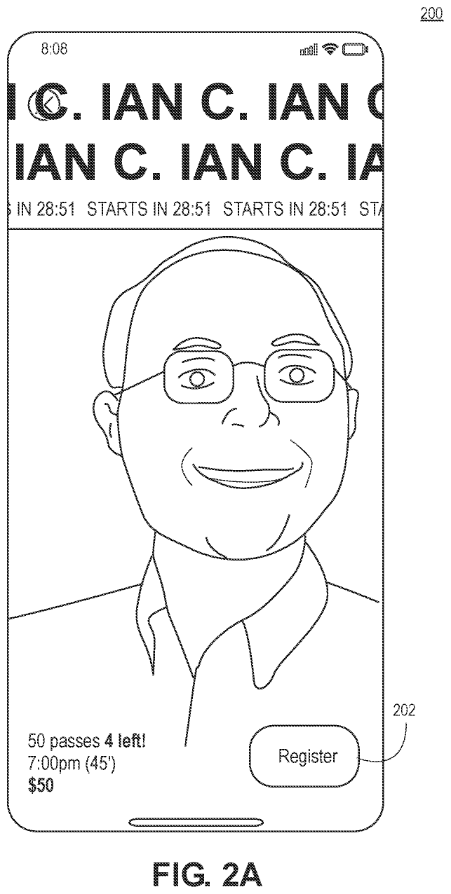

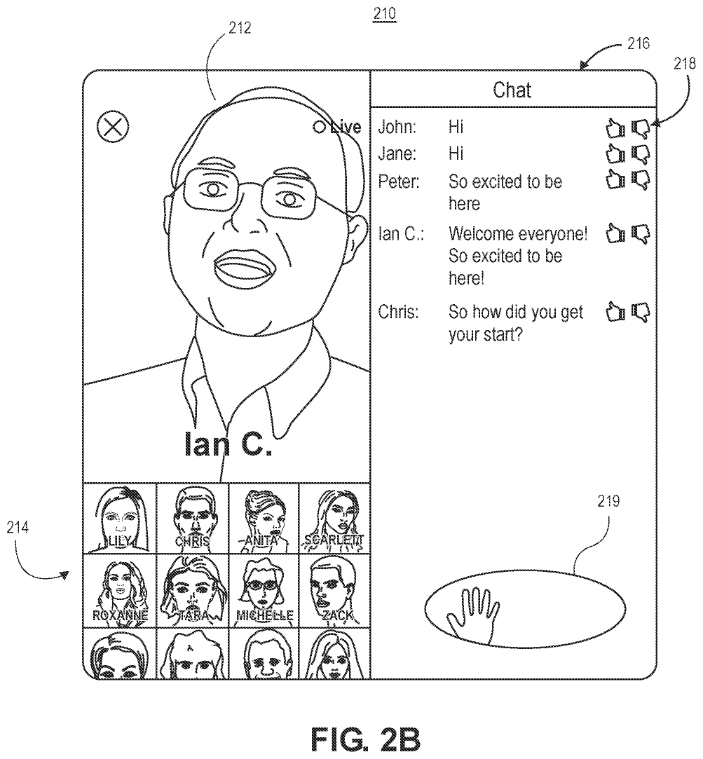

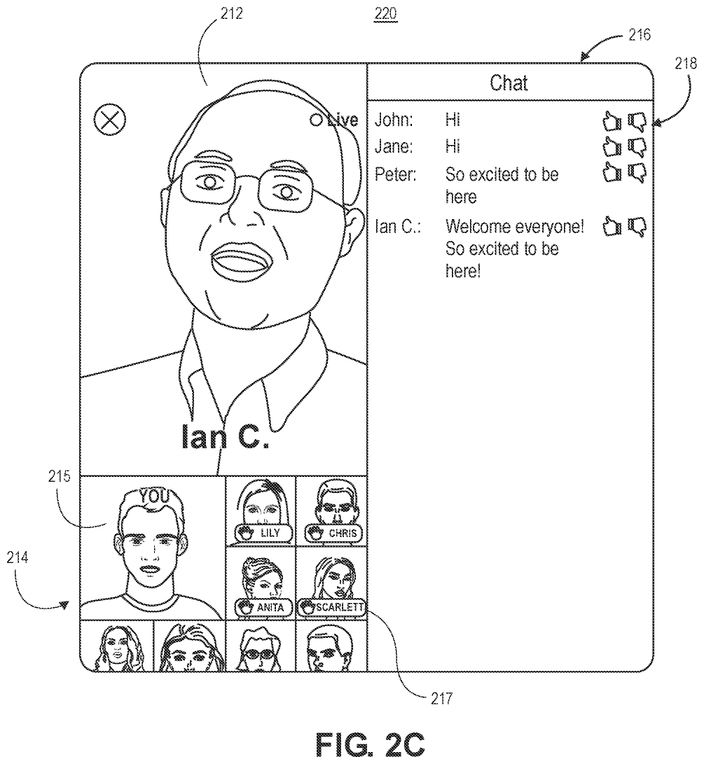

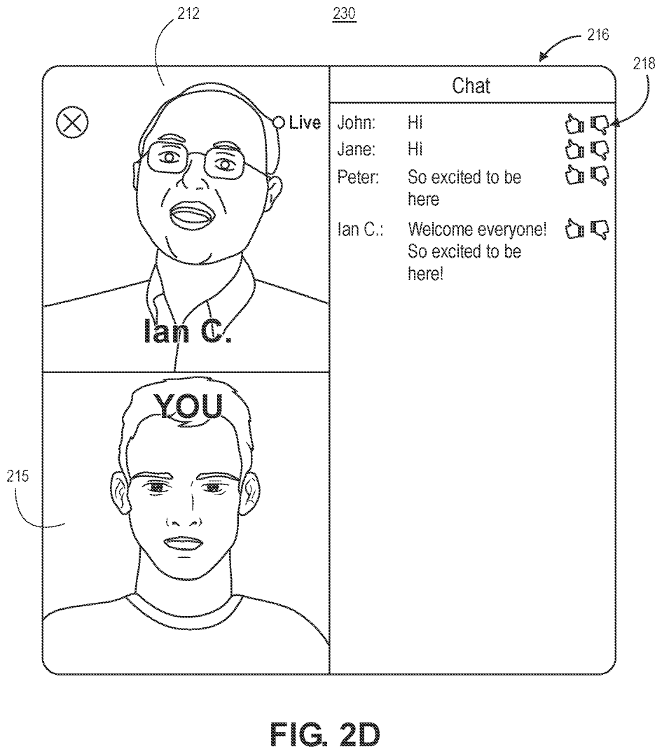

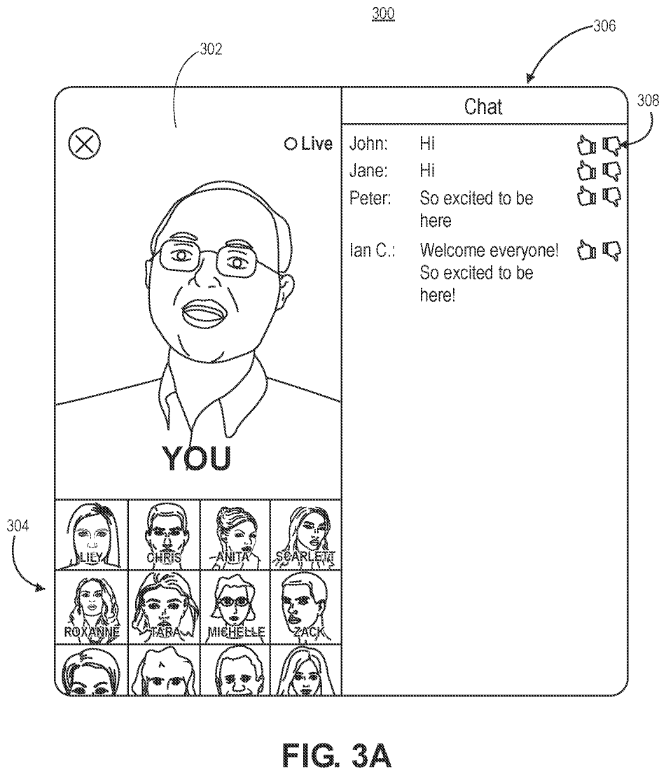

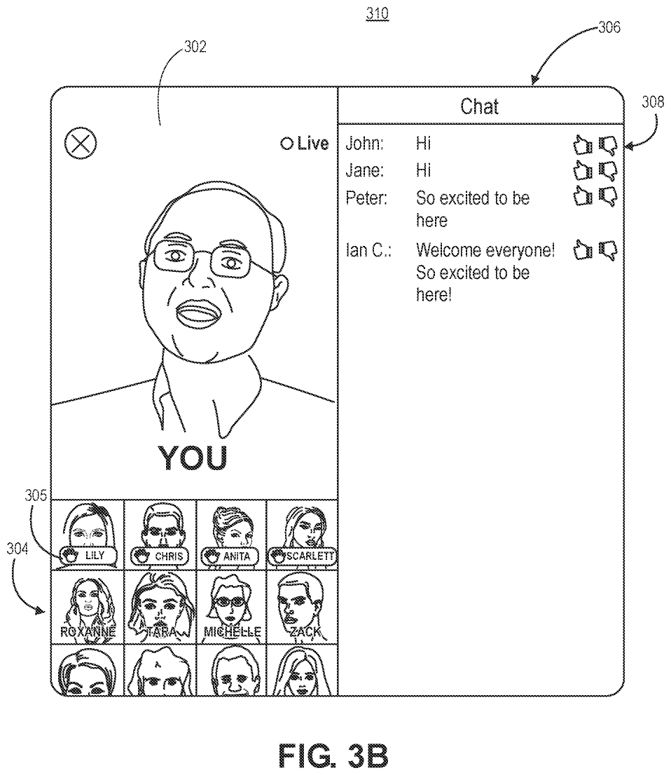

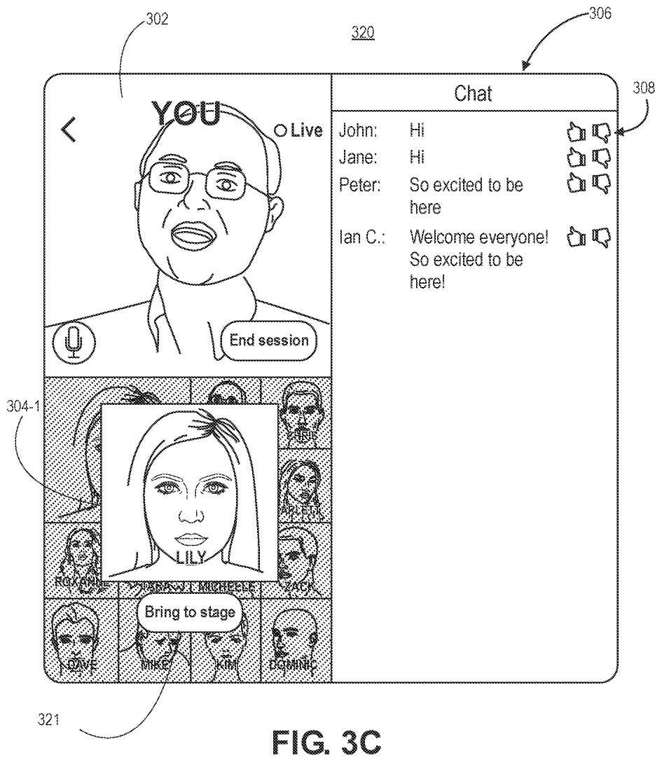

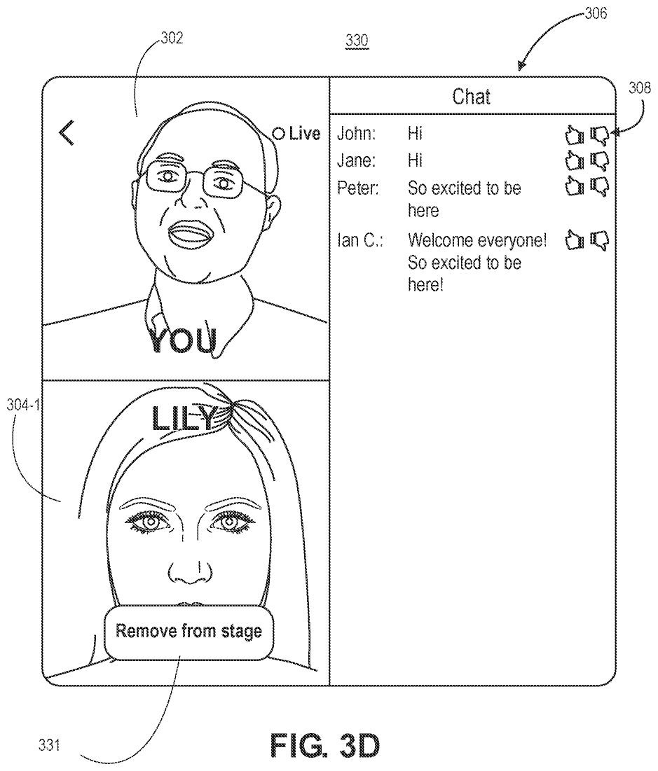

Accordingly, a host (e.g., a content creator) associated with host client device 130 may communicate with interactive video service 145 to create a live, interactive, livestream session. Interactive video service 145 may create the live, interactive, livestream session, as well as a session location identifier associated with the live, interactive, livestream session. The live, interactive, livestream session may be accessed and/or attended, via the session location identifier, by users associated with a respective client device 110. For example, a user associated with client device 110 may register and purchase access to the live, interactive, livestream session, which may be confirmed, verified, and/or processed by interactive video service 145. After a live, interactive, livestream session has been initiated between host client device 130 and one or more client device(s) 110, livestream feeds from host client device 130 and each client device 110 may be presented, via user interfaces, on each of host client device 130 and client device(s) 110. Additionally, the host and participants may engage in a direct interaction/engagement via host client device 130 and client device(s) 110. Exemplary user interfaces that may be presented on host client device 130 and/or client device(s) 110 to facilitate interaction and engagement between participants/attendees and/or the host during the live, interactive, livestream session are shown and described in further detail herein in connection with FIGS. 2A-3D.

FIGS. 2A-2D are illustrations of exemplary user interfaces that may be presented on a client device to participants/attendees of a live, interactive, livestream session hosted by an interactive video service, according to exemplary embodiments of the present disclosure. As will be appreciated, any variation of processing and/or other operation of the disclosed implementations may be performed on one or many different devices. Likewise, the disclosed implementations, may, for example, be provided as part of a social networking environment, e-commerce environment, or any other form of interactive computing.

FIG. 2A is an illustration of exemplary user interface 200 presented on a display of a client device (e.g., client device 110) displaying information associated with a live, interactive, livestream session. User interface 200 may include a listing for a live, interactive, livestream session and may be presented to on client devices of users who may be shopping for and/or looking to register for a live, interactive, livestream session. In the example implementation illustrated in FIG. 2A, the listing for the live, interactive, livestream session may have been created (e.g., by interactive video service 145), along with the session locator identifier, and user interface 200 may be presented to a user who has navigated to the location specified by the session location identifier. As shown in FIG. 2A, the listing for the live, interactive, livestream session presented on user interface 200 may present certain information associated with the live, interactive, livestream session, such as the host, the start time and duration, the cost, the number of available tickets, the number of remaining tickets, and the like. Additionally, the listing presented on user interface 200 may include registration control 202, through which the user may register and pay for the live, interactive, livestream session.

Optionally, user interface 200 may offer multiple tiers and/or levels of access to the live, interactive, livestream session presented in the listing. For example, a first tier or level of access may grant the participant the ability to merely listen in on the live, interactive, livestream session (e.g., without the ability to participate and/or interact with the host, etc.), a second level of access may include video (e.g., without the ability to participate and/or interact with the host, etc.), a third level of access may include the ability to participate and/or interact with the host, a fourth level of access may include a priority in connection with participations and/or interactions with the host, a fifth level of access may provide a private (or for a relatively small number of participants) session with the host before or after the live, interactive, livestream session, a sixth level of access may also include a recording of the live, interactive, livestream session, and the like. Upon purchase of access to the live, interactive, livestream session, the user may gain access to the live, interactive, livestream session.

Optionally, the live, interactive, livestream session may also be recorded. For example, the host may elect to enable recording of the live, interactive, livestream session. Access to the recorded session may then be offered by the host for purchase, be provided to participants who purchased certain levels/tiers of access to the session, and the like.

According to certain exemplary implementations of the present disclosure, the information and registration control 202 presented by user interface 200 may be presented in connection with a marketplace for live, interactive, livestream sessions. For example, one or more listings of upcoming live, interactive, livestream sessions, such as the one presented in user interface 200, may be presented such that a user may be able to peruse, search, and/or register for upcoming live, interactive, livestream sessions.

FIG. 2B is an illustration of exemplary user interface 210 presented on a display of a client device (e.g., client device 110) associated with a participant/attendee during a live, interactive, livestream session. User interface 210 may be presented to the participant after the user has navigated to the session location created in connection with the creation of the live, interactive, livestream session. Accordingly, the user may have already registered and paid for participation and/or access to the live, interactive, livestream session, which may have been confirmed and/or verified by the interactive video service (e.g., by interactive video service 145), which may be configured to create, host, and/or manage the live, interactive, livestream session.

As shown in FIG. 2B, user interface 210 may include livestream feed 212 of the host of the live, interactive, livestream session, which may be prominently displayed in user interface 210, participants 214 of the live, interactive, livestream session, and chat module 216, which may include upvote and downvote controls 218. For example, livestream feed 212 may be obtained from a client device (e.g., host client device 130) associated with the host of the live, interactive, livestream session, and broadcast and presented via user interface 210 to participants 214 of the live, interactive, livestream session. Chat module 216 can facilitate a text-based exchange between the host and the participants of the live, interactive, livestream session to present questions, comments, discussions, emojis, etc., and upvote and/or downvote chat module 216 entries via upvote and downvote controls 218 to interact with the host of the live, interactive, livestream session. Additionally, user interface 210 may present a graphical representation of each participant 214. For example, user interface 210 may present a corresponding livestream feed for each participant 214 obtained from client devices associated with each respective participant. Alternatively and/or in addition, user interface 210 may present a static object (e.g., a profile picture, avatar, image, etc.) for each participant 214. The static object may be provided by each respective participant 214, obtained from a remote data store that is accessible to the interactive video service (e.g., from a social networking service, the Internet, etc.), obtained from a memory on the client device, may be generated from a camera or other imaging element of the client device, etc.

Through livestream feed 212 of the host of the live, interactive, livestream session, the host may provide an intimate setting through which to interact with participants, who may be fans, followers, consumers of his/her content, and the like. For example, via livestream feed 212, the host may discuss a recently created work, host a question-and-answer session, perform a demonstration, perform a musical performance, perform a reading, or host any other activity or event. Accordingly, participants may view livestream feed 212 of the host presented by user interface 210 on his/her client device in substantially real-time.

In the exemplary illustration, the participant may also interact with user interface 210 to indicate a request for a direct interaction and/or engagement with the host of the live, interactive, livestream session. For example, user interface 210 may include participant control 219, through which the participant may request a direct interaction and/or engagement with the host of the live, interactive, livestream session. The request for direct interaction and/or engagement may be made so that the participant may ask the host a question, engage in a dialogue or discussion on a topic of his/her choosing, perform a demonstration for the host, and the like. This can be the digital equivalent of bringing someone on stage during the live, interactive, livestream session. Accordingly, upon selection of participant control 219 via an interaction with user interface 210, a user interface presented on the client device associated with the host of the live, interactive, livestream session, as well as user interfaces presented on client devices associated with other participants of the live, interactive, livestream session, may include an indication in association with the requesting participant that the participant has made a request for direct interaction and/or engagement. As shown and described further herein in connection with FIGS. 3A-3C, the host of the live, interactive, livestream session may select a participant for direct interaction and/or engagement.

FIG. 2C is an illustration of exemplary user interface 220, which may be presented on a display of a client device (e.g., client device 110) associated with a participant who has been selected for direct interaction and/or engagement with the host of the live, interactive, livestream session, according to exemplary embodiments of the present disclosure. As with user interface 210 shown in FIG. 2B, user interface 220 also presents livestream feed 212 of the host of the live, interactive, livestream session, participants 214, and chat module 216, which can facilitate a text-based exchange between the host and the participants of the live, interactive, livestream session to present questions, comments, discussions, emojis, etc., and upvote and/or downvote chat module 216 entries via upvote and downvote controls 218 to interact with the host of the live, interactive, livestream session.

Additionally, as shown in FIG. 2C, user interface 220 may prominently display, present, and/or indicate the participant who has been selected (e.g., in response to a request for direct interaction and/or engagement with the host of the live, interactive, livestream session) for direct engagement and/or interaction with the host of the live, interactive, livestream session. In the example implementation illustrated in FIG. 2C, interactive participant 215 may be presented more prominently (e.g., larger, with different colors, bolder, highlighting, framing, etc.) relative to the other participants 214. The relative prominence can indicate that interactive participant 215 has been selected by the host of the live, interactive, livestream session to engage in the direct interaction. Additionally, interactive participant 215 may be presented as a livestream video feed (e.g., via user interfaces presented on the client device associated with the host of the live, interactive, livestream session, as well on client devices associated with other participants of the live, interactive, livestream session) such that the host and the other participants can view the interaction between the host of the live, interactive, livestream session and interactive participant 215. Further, each participant 214 who has requested direct interaction and/or engagement with the host of the live, interactive, livestream session may be presented with an associated request indicator 217, indicating that the respective participant 214 has requested direct interaction and/or engagement with the host of the live, interactive, livestream session. According to certain aspects, the host and the selected participant/attendee may be displayed more prominently on only the client devices associated with the host and the selected participant/attendee. The client devices of participants/attendees not engaging in a direct interaction and/or engagement with the host may simply present livestream feeds of the host and the selected participant/attendee (e.g., so they can follow along with the direct interaction and/or engagement) but not in a manner where the selected participant/attendee is presented more prominently. Alternatively and/or in addition, the host and the selected participant/attendee may be displayed more prominently on the client devices associated with the host and all participants/attendees.

FIG. 2D is an illustration of exemplary user interface 230, which may be presented on a display of a client device (e.g., client device 110) associated with a participant who has been selected for direct interaction and/or engagement with the host of the live, interactive, livestream session, according to exemplary embodiments of the present disclosure. As with user interfaces 210 and 220 shown in FIGS. 2B and 2C, user interface 230 also presents livestream feed 212 of the host of the live, interactive, livestream session, and chat module 216, which can facilitate a text-based exchange between the host and the participants of the live, interactive, livestream session to present questions, comments, discussions, emojis, etc. and upvote and/or downvote chat module 216 entries via upvote and downvote controls 218 to interact with the host of the live, interactive, livestream session.

Additionally, as shown in FIG. 2D, user interface 230 may prominently display and/or present the participant who has been selected (e.g., in response to a request for direct interaction and/or engagement with the host of the live, interactive, livestream session) for direct engagement and/or interaction with the host of the live, interactive, livestream session. In the example implementation illustrated in FIG. 2D, interactive participant 215 may be presented prominently in a split-screen arrangement with livestream feed 212 of the host of the live, interactive, livestream session. Accordingly, the split screen arrangement may further emphasize the direct interaction and/or engagement between the host of the live, interactive, livestream session and interactive participant 215 to give interactive participant 215 the impression of an intimate in-person interaction with the host of the live, interactive, livestream session. Alternatively and/or in addition, the host and the selected participant/attendee may only be displayed more prominently (e.g., in a split-screen arrangement) on the client devices associated with the host and the selected participant/attendee. The client devices of participants/attendees not engaging in a direct interaction and/or engagement with the host may simply present livestream feeds of the host and the selected participant/attendee (e.g., so they can follow along with the direct interaction and/or engagement) but not in a manner where the selected participant/attendee is presented more prominently. Alternatively and/or in addition, the host and the selected participant/attendee may be displayed more prominently on the client devices associated with the host and all participants/attendees.

FIGS. 3A-3D are illustrations of exemplary user interfaces that may be presented on a client device of a host of a live, interactive, livestream session hosted by an interactive video service, according to exemplary embodiments of the present disclosure. As will be appreciated any variation of processing and/or other operation of the disclosed implementations may be performed on one or many different devices. Likewise, the disclosed implementations, may, for example, be provided as part of a social networking environment, e-commerce environment, or any other form of interactive computing.

FIGS. 3A and 3B are illustrations of exemplary user interfaces 300 and 310 presented on a display of a client device (e.g., host client device 130) associated with a host of a live, interactive, livestream session. User interfaces 300 and 310 may be presented to the host after the session has been created and initiated. Accordingly, the host may have requested creation of the live, interactive, livestream session using an interactive video service (e.g., interactive video service 145), which may be configured to create, host, and/or manage the live, interactive, livestream session.

As shown in FIGS. 3A and 3B, user interfaces 300 and 310 may include livestream feed 302 of the host of the live, interactive, livestream session, which may be prominently displayed in user interfaces 300 and 310, participants 304 of the live, interactive, livestream session, and chat module 306, which may include upvote and downvote controls 308. For example, livestream feed 302 may be obtained from a video recording sensor of a client device (e.g., host client device 130) associated with the host of the live, interactive, livestream session, and presented via user interface 300 to the host, as well as participants, of the live, interactive, livestream session. Chat module 306 can facilitate a text-based exchange between the host and the participants of the live, interactive, livestream session to present questions, comments, discussions, emojis, etc., and upvote and/or downvote chat module 306 entries via upvote and downvote controls 308 to interact with the host of the live, interactive, livestream session.

Additionally, user interfaces 300 and 310 may present a graphical representation of each participant 304. For example, user interfaces 300 and 310 may present a corresponding livestream feed for each participant 304 obtained from client devices associated with each respective participant. Alternatively and/or in addition, user interfaces 300 and 310 may present a static object (e.g., a profile picture, avatar, image, etc.) for each participant 304. The static object may be provided by each respective participant 304, obtained from a remote data store that is accessible to the interactive video service (e.g., from a social networking service, the Internet, etc.), obtained from a memory on the client device, may be generated from a camera or other imaging element of the client device, etc.

Through livestream feed 302, the host may be able to interact with participants, who may be fans, followers, consumers of his/her content, and the like, in an intimate setting. For example, via livestream feed 302, the host may discuss a recently created work, host a question-and-answer session, perform a demonstration, perform a musical performance, perform a reading, or host any other activity or event. Accordingly, participants may view livestream feed 302 of the host, which may be presented by a user interface on his/her client device in substantially real-time.

Additionally, user interface 310 may include indicators 305, that may identify participants 304 who have requested a direct interaction and/or engagement with the host. As shown in FIG. 3B, participants 304 who have requested a direct interaction and/or engagement with the host may include indicator 305 in association with his/her graphical representation (e.g., livestream feed, avatar, profile picture, etc.). Further, participants who have requested direct interaction and/or engagement with the host may be presented in user interface 310 in accordance with priorities that have been determined in connection with each participant 304.

In implementations where a request for direct interaction and/or engagement is received from more than one participant 304, embodiments of the present disclosure can determine a priority associated with each participant 304 requesting direct interaction and/or engagement. For example, the priority associated with each participant/attendee may be based on an order in which the direct interaction and/or engagement was requested, user history between the participant and the host, crowd sourced upvoting and/or downvoting of the participants, the purchased access type/level, and the like. For example, an engagement score may be determined for each participant 304 requesting direct interaction and/or engagement with the host. The engagement score may be an aggregation (e.g., normalized weighted sum, etc.) of the participant's history in connection with the host's content. This may include, for example, whether the participant subscribes to content created by the host, has attended previous sessions, the frequency and amount of purchases from the host, comments made by the participant in connection with the host's content, and the like.

According to certain exemplary implementations, the live, interactive, livestream session may have been created offering different types, levels, and/or tiers of access. For example, there may be a basic access type/level/tier where participants are not provided the option to request direct interaction and/or engagement with the host, a standard type/level/tier where participants may request access and will be provided a standard priority preference, a VIP type/level/tier where participants will be provided a higher priority preference in connection with requests for direct interaction and/or engagement. Additionally, each type/level/tier may be capped to a certain number of participants. Any number of access types, levels, and/or tiers may be established with different benefits conferred at each type, level, and/or tier.

Additionally, aspects of the present disclosure may also consider negative user history (e.g., behavior in previous sessions, comments left in response to content, and the like) in determining priority and/or blocking specific participants/attendees from directly interacting and/or engaging with the host. Other relevant types of information may also be considered in determining a priority associated with a participant's request for direct interaction and/or engagement with the host.

Accordingly, the participants/attendees requesting direct interaction and/or engagement with the host may be presented on the client device associated with the host in accordance with the priorities assigned to each participant. In the implementation illustrated in FIG. 3B, Lily may have the highest priority, followed by Chris, Anita, and then Scarlett. The host may then select a participant/attendee, via an interaction with the user interface, to initiate the direct interaction and/or engagement with the participant/attendee.

FIG. 3C is an illustration of exemplary user interface 320, which may be presented on a display of a client device (e.g., host client device 130) associated with a host in connection with a participant who has requested direct interaction and/or engagement with the host of the live, interactive, livestream session, according to exemplary embodiments of the present disclosure. As with user interfaces 300 and 310 shown in FIGS. 3A and 3B, user interface 320 also presents livestream feed 302 of the host of the live, interactive, livestream session, which may be prominently displayed, participants 304 of the live, interactive, livestream session, and chat module 306, which may include upvote and downvote controls 308.

FIG. 3C illustrates an implementation where the priorities associated with each participant have been determined, and user interface 320 is presenting the participant having the highest associated priority. In the implementation illustrated in FIG. 3C, participant 304-1 (i.e., Lily) may have requested a direct interaction and/or engagement with the host of the live, interactive, livestream session and may have the highest associated priority. Accordingly, as shown in FIG. 3C, participant 304-1 may be prominently presented (e.g., overlayed, presented larger, etc.) on user interface 320 such that the host may quickly interact with user interface 320 with direct interaction control 321 to select participant 304-1 for a direct interaction and/or engagement. Alternatively and/or in addition, a control to refuse the request for direct interaction, as well as information associated with the participant (e.g., user history, past comments, etc.) may also be presented on user interface 320.

FIG. 3D is an illustration of exemplary user interface 330, which may be presented on a display of a client device (e.g., host client device 130) associated with a host of the live, interactive, livestream session during a direct interaction and/or engagement session with a participant, according to exemplary embodiments of the present disclosure. As with user interfaces 300, 310, and 320 shown in FIGS. 3A-3C, user interface 330 also presents livestream feed 302 of the host of the live, interactive, livestream session, and chat module 306, which can facilitate a text-based exchange between the host and the participants of the live, interactive, livestream session to present questions, comments, discussions, emojis, etc., and upvote and/or downvote chat module 306 entries via upvote and downvote controls 308 to interact with the host of the live, interactive, livestream session.

Additionally, as shown in FIG. 3D, user interface 330 may prominently display and/or present the participant who has been selected (e.g., in response to a request for direct interaction and/or engagement with the host of the live, interactive, livestream session) for direct engagement and/or interaction with the host of the live, interactive, livestream session. In the example implementation illustrated in FIG. 3D, interactive participant 304-1 may be presented prominently in a split-screen arrangement with livestream feed 302 of the host of the live, interactive, livestream session. Accordingly, the split screen arrangement may further emphasize the direct interaction and/or engagement between the host of the live, interactive, livestream session and interactive participant 304-1, to give the participant the impression of an intimate in-person interaction with the host of the live, interactive, livestream session. Alternative presentations may also be presented where interactive participant 304-1 is displayed more prominently relative to participants 304 but is not displayed in a split-screen arrangement (e.g., similar to the implementation shown in FIG. 2C, etc.). Additionally, as shown in FIG. 3D, user interface 330 may also include end direct interaction control 331, which can facilitate ending of the direct interaction with participant 304-1, so that another participant 304 may be selected a direct interaction and/or engagement with the host.

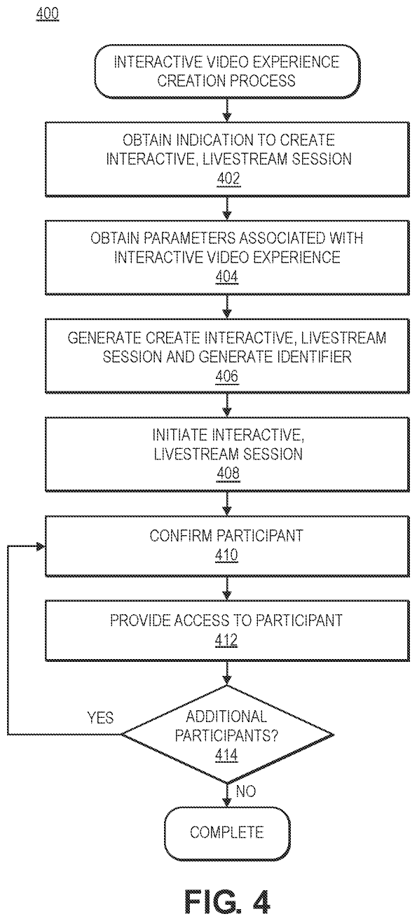

FIG. 4 is a flow diagram of an exemplary interactive, video experience creation process 400, according to exemplary embodiments of the present disclosure.

As shown in FIG. 4, process 400 may begin with obtaining an indication to create a live, interactive, livestream session, as in step 402. For example, this may include a content creator requesting and configuring the creation of a live, interactive, livestream session. As part of the request to create the live, interactive, livestream session, in step 404, parameters associated with the live, interactive, livestream session may be obtained. This may include, for example, the format and/or the content of the live, interactive, livestream session (e.g., a demonstration, a question and answer session, a discussion on a certain topic, and the like), a maximum number of participants, a cost to access the live, interactive, livestream session, the date and time at which the live, interactive, livestream session may begin, a duration for the live, interactive, livestream session, types of access (e.g., attendee, active participant, priority access, etc.) to the live, interactive, livestream session, and the like.

Based on the request to create the live, interactive, livestream session and the associated parameters, in step 406, the live, interactive, livestream session can be created and an identifier for the live, interactive, livestream session can be generated and associated with the live, interactive, livestream session. For example, a session location identifier (e.g., a uniform resource locator “URL”, etc.) that may specify where the live, interactive, livestream session is being hosted and can be accessed may be generated and associated with the live, interactive, livestream session. The identifier may be provided in the form of a link to a URL, which can be distributed or made available to consumers who may be interested in attending the live, interactive, livestream session. Accordingly, anyone desiring to attend the live, interactive, livestream session may navigate to the location specified by the session location identifier (e.g., selecting a link to a URL, etc.) to register and access the live, interactive, livestream session.

In steps 408 and 410, the live, interactive, livestream session may be initiated and participants seeking to access the live, interactive, livestream session may be confirmed. For example, a user may, via a client device, submit one or more credentials (e.g., username/password, biometrics, secure token, etc.), which may be verified, so that the user may access the live, interactive, livestream session between client devices. In one illustrative implementation, after a live, interactive, livestream session has been created, along with a session location identifier, a user may navigate to the location specified by the session location identifier and/or launch or execute an application on a client device to register for and access the live, interactive, livestream session. The user may provide credentials to process payment for access to the live, interactive, livestream session, and participate in the live, interactive, livestream session, and the like. Accordingly, upon confirmation of the participant (e.g., confirmation of payment, etc.), access may be provided to the participant, as in step 412, and it can be confirmed whether additional participants are requesting access, as in step 414. Further, upon confirmation of each participant to the live, interactive, livestream session, the various input/output devices (e.g., microphones, cameras, etc.) for each of the participants may be automatically disabled, and the participants may not be provided with the ability to change the disabling of such input/output device. The ability to enable and/or disable the input/output devices may only be provided to the host of the live, interactive, livestream session. Participants may be confirmed until no additional participants are requesting access to the live, interactive, livestream session and/or a maximum number of participants has been reached.

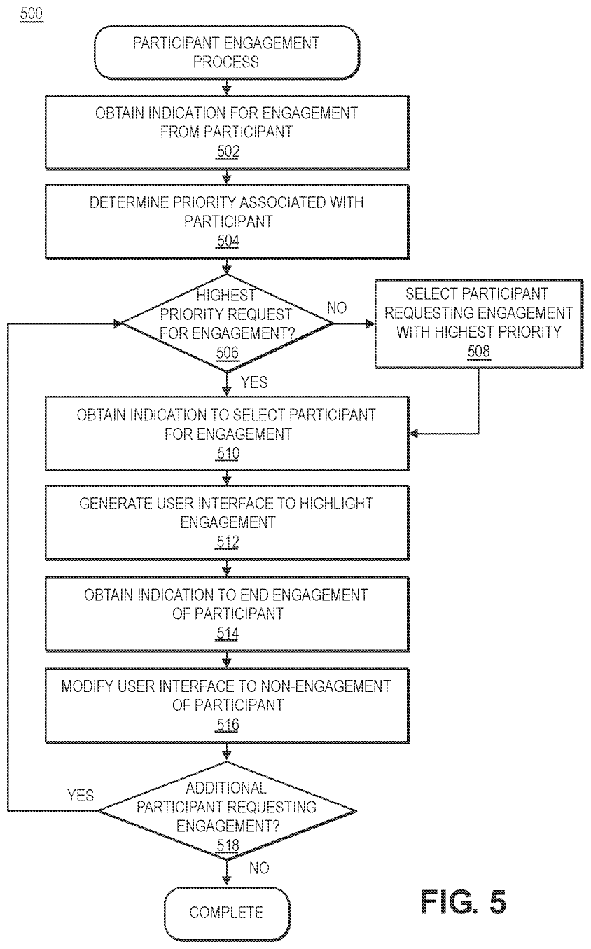

FIG. 5 is a flow diagram of an exemplary participant engagement process 500, according to exemplary embodiments of the present disclosure.

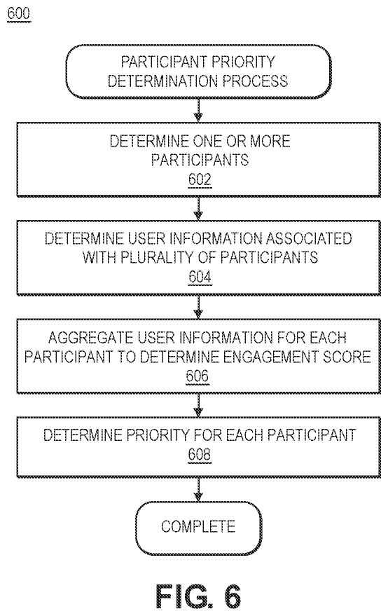

As shown in FIG. 5, process 500 may begin with obtaining, from one or more participants, an indication for direct engagement and/or interaction with the host of a live, interactive, livestream session, as in step 502. For example, a participant may select a control presented on a user interface of a client device to indicate a request for a direct interaction and/or engagement with the host. Accordingly, a user interface presented on a client device associated with the host may present a corresponding indication in association with the participant indicating that the participant is requesting a direct interaction and/or engagement with the host. In step 504, a priority may be determined in connection with the participants requesting direct engagement and/or interaction with the host. This may be determined, for example, as illustrated and described in connection with FIG. 6.

Based on the determined priorities, in step 506, it can be determined whether the participant requesting direct access and/or interaction is associated with the highest determined priority. If the participant does not have the highest associated priority, the participant requesting direct engagement and/or interaction with the highest associated priority may be selected, as in step 508. In step 510, an indication selecting the participant for direct engagement and/or interaction may be obtained.

In step 512, a user interface highlighting the direct engagement and/or interaction may be generated and presented on the client devices associated with the host and/or one or more participants (including the participant selected for direct interaction and/or engagement). For example, the participant selected for direct engagement and/or interaction may be more prominently presented relative to the other participants participating in the live, interactive, livestream session. The visual representation associated with the selected participant may be presented larger than the visual representations associated with the other participants, a livestream feed of the selected participant may be presented, the selected participant and the host may be presented in a split-screen arrangement, and the like. Further, during the direct interaction and/or engagement the input/output devices (e.g., microphones, cameras, etc.) of the participant selected for the direct interaction and/or engagement may be enabled, while the input/output devices (e.g., microphones, cameras, etc.) for each of the other participants may be remain disabled so as to not interrupt the direct interaction and/or engagement session.

At the conclusion of the direct interaction and/or engagement between the host and the selected participant, an indication to end the direct engagement and/or interaction may be obtained, as in step 514. For example, each direct interaction and/or engagement may have an associated time limit, may be ended by the host, may be ended by the participant, or the like. In step 516, the user interface may be modified so that no participant is highlighted, since a direct engagement and/or interaction between the selected participant and the host would have concluded. In step 518, it can be determined if another participant is requesting direct engagement and/or interaction. If there is another participant that is requesting direct engagement and/or interaction, process 500 returns to step 506.

FIG. 6 is a flow diagram of an exemplary participant priority determination process 600, according to exemplary embodiments of the present disclosure.

As shown in FIG. 6, process 600 may begin with determining one or more participants of a live, interactive, livestream session, as in step 602. This may include, for example, all participants attending a live, interactive, livestream session, or it may include the participants who are requesting a direct interaction and/or engagement with the host of the live, interactive, livestream session. In step 604, user information associated with the plurality of participants may be obtained. According to certain aspects, this may include each participant's history in connection with the host's content. This may include, for example, whether the participant subscribes to content created by the host, has attended previous sessions, the frequency and amount of purchases of the host's content, type of access purchased for the session, crowd sourced upvoting and/or downvoting of the participants, and the like. Additionally, aspects of the present disclosure may also consider negative user history (e.g., behavior in previous sessions, comments left in response to content, and the like) in determining priority and/or blocking specific participants/attendees from directly interacting and/or engaging with the host.

In step 606, the user information for each participant may be aggregated to determine an engagement for each participant. The engagement score may be an aggregation (e.g., normalized weighted sum, etc.) of the participant's history (e.g., positive and/or negative information) in connection with the host's content. Based on the engagement score for each participant, a priority may be determined for each participant, as in step 608. For example, this can include a ranking of each participant based on the engagement score associated with each participant.

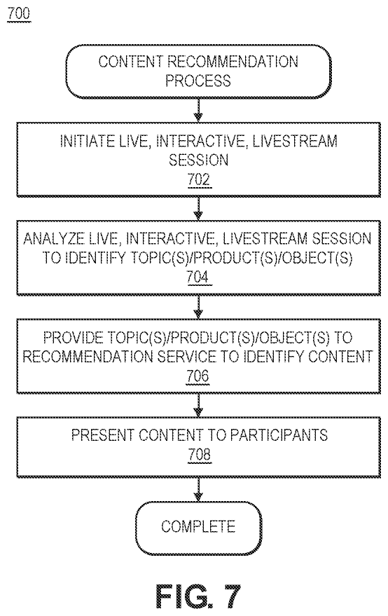

FIG. 7 is a flow diagram of an exemplary content recommendation process 700, according to exemplary embodiments of the present disclosure.

As shown in FIG. 7, process 700 may begin with the initiation of a live, interactive, livestream session, as in step 702. During the live, interactive, livestream session, various aspects of the live, interactive, livestream session may be analyzed, as in step 704, to determine and/or identify content (e.g., content items from a corpus of content items, ads, object identifiers, etc.) to present to the participants of the live, interactive, livestream session. For example, the conversation and/or dialogue (spoken and written in a chat module) between the host and one or more participants may be obtained and analyzed and/or processed (e.g., using natural language processing (NLP) techniques) to identify a topic of the live, interactive, livestream session. Alternatively and/or in addition, products and/or images displayed on-screen by the host may be analyzed and/or processed (e.g., using image processing techniques, embedding vectors, etc.) to identify one or more products and/or objects presented during the live, interactive, livestream session. Other aspects of the live, interactive, livestream session may also be analyzed using other techniques and/or methods.

In step 706, the topics, products, objects and the like obtained through an analysis of the live, interactive, livestream session may be provided to a recommendation service, which may be configured to identify one or more content items (e.g., from a corpus of content items) that are relevant to the identified topics, products, objects, and the like, may be identified and/or presented to participants of the live, interactive, livestream session. For example, ads related to the identified topics, products, objects, and the like may be identified by the recommendation service. Alternatively and/or in addition, content items (e.g., images, videos, articles, etc.) related to the identified topics, products, objects, and the like, may be identified by the recommendation service. According to yet another implementation, links to products which can facilitate purchase of the products related to the identified topics, products, objects, and the like may be identified by the recommendation service.

In step 708, the identified content (e.g., ads, content items, products, etc.) may be presented to the participants during and/or after the live, interactive, livestream session. According to certain aspects of the present disclosure, the identification of related and/or recommended content may be disabled and/or enabled by the host of the live, interactive, livestream session. Alternatively and/or in addition, the content may be presented (or not presented) based on the level and/or tier of access to the live, interactive, livestream session.

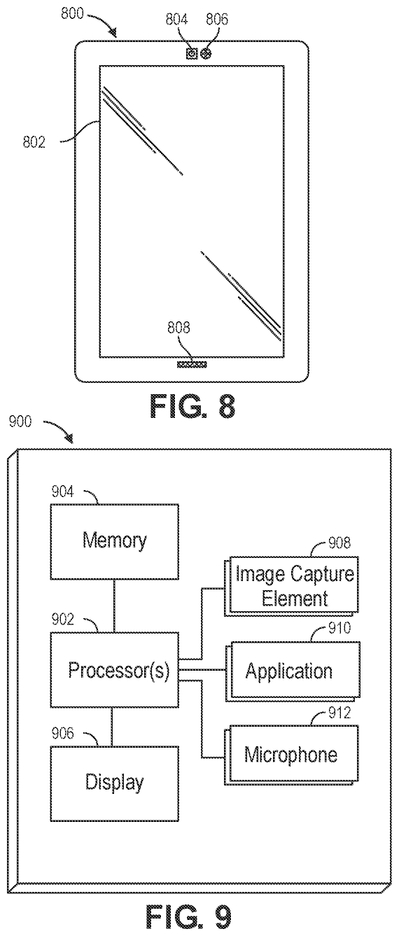

FIG. 8 illustrates an exemplary client device 800 that can be used in accordance with various implementations described herein. In this example, client device 800 includes display 802 and optionally, at least one input component 804, such as a camera, on a same side and/or opposite side of the device as display 802. Client device 800 may also include an audio transducer, such as speaker 806, and microphone 808. Generally, client device 800 may have any form of input/output components that allow a user to interact with client device 800. For example, the various input components for enabling user interaction with the device may include touch-based display 802 (e.g., resistive, capacitive, Interpolating Force-Sensitive Resistance (IFSR)), camera (for gesture tracking, etc.), microphone, global positioning system (GPS), compass or any combination thereof. One or more of these input components may be included on a user device or otherwise in communication with the user device. Various other input components and combinations of input components can be used as well within the scope of the various implementations, as should be apparent in light of the teachings and suggestions contained herein.

In order to provide the various functionality described herein, FIG. 9 illustrates an exemplary set of components 900 of client device 800, such as client device 800 described with respect to FIG. 8 and discussed herein. In this example, the device includes at least one central processor 902 for executing instructions that can be stored in at least one memory device or element 904. As would be apparent to one of ordinary skill in the art, the device can include many types of memory, data storage or computer-readable storage media, such as a first data storage for program instruction for execution by the one or more processors 902. Removable storage memory can be available for sharing information with other devices, etc. The device typically will include some type of display 906, such as a touch-based display, electronic ink (e-ink), organic light emitting diode (OLED), liquid crystal display (LCD), etc.

As discussed, the device in many implementations will include at least one image capture element 908, such as one or more cameras that are able to capture an image of objects in the vicinity of the device. An image capture element can include, or be based at least in part upon, any appropriate technology, such as a CCD or CMOS image capture element having a determined resolution, focal range, viewable area, and capture rate. The device can include at least one application component 910 for performing the implementations discussed herein, such as hosting and/or participating in a live, interactive, livestream session. The user device may be in constant or intermittent communication with one or more remote computing resources and may exchange information, such as livestream feeds, chat messages, etc., with the remote computing system(s) as part of the disclosed implementations.

The device also can include at least one location component, such as GPS, NFC location tracking, Wi-Fi location monitoring, etc. Location information obtained by the location component may be used with the various implementations discussed herein as a factor in, for example, determining location of a participant and/or host of a live, interactive, livestream session and from a livestream feed generated by image capture element 908 and microphone 912 of the client device while hosting and/or participating in a live, interactive, livestream session.

The example client device may also include at least one additional input device able to receive conventional input from a user. This conventional input can include, for example, a push button, touch pad, touch-based display, wheel, joystick, keyboard, mouse, trackball, keypad or any other such device or element whereby a user can submit an input to the device. These I/O devices could be connected by a wireless, infrared, Bluetooth, or other link as well in some implementations. In some implementations, however, such a device might not include any buttons at all and might be controlled only through touch inputs (e.g., touch-based display), audio inputs (e.g., spoken), or a combination thereof.

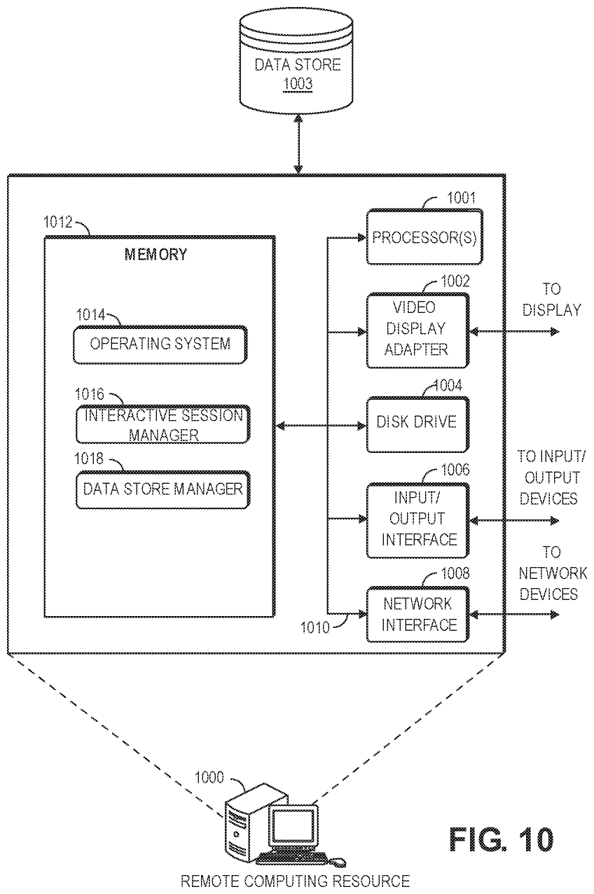

FIG. 10 is a pictorial diagram of an illustrative implementation remote computing resource 1000 that may be used with one or more of the implementations described herein. Remote computing resource 1000 may include one or more processors 1001, such as one or more redundant processors, video display adapter 1002, disk drive 1004, input/output interface 1006, network interface 1008, and memory 1012. Processor(s) 1001, video display adapter 1002, disk drive 1004, input/output interface 1006, network interface 1008, and memory 1012 may be communicatively coupled to each other by communication bus 1010.

Video display adapter 1002 provides display signals to a local display permitting an operator of remote computing resource 1000 to monitor and configure operation of remote computing resource 1000. Input/output interface 1006 likewise communicates with external input/output devices not shown in FIG. 10, such as a mouse, keyboard, scanner, or other input and output devices that can be operated by an operator of remote computing resource 1000. Network interface 1008 includes hardware, software, or any combination thereof, to communicate with other computing devices. For example, network interface 1008 may be configured to provide communications between remote computing resource 1000 and other computing devices, such as client device 800.

Memory 1012 generally comprises random access memory (RAM), read-only memory (ROM), flash memory, and/or other volatile or permanent memory. Memory 1012 is shown storing operating system 1014 for controlling the operation of remote computing resource 1000.

Memory 1012 additionally stores program code and data for providing network services that allow client device 800 and external sources to exchange information and data files with remote computing resource 1000. Memory 1012 may also include interactive session manager application 1016 that creates, hosts, and manages the live, interactive, livestream sessions that different users may utilize according to disclosed implementations. Interactive session manager application 1016 may communicate with data store manager application 1018 to facilitate data exchange and mapping between the data store 1003, user/client devices, such as client device 800, external sources, etc.

As used herein, the term “data store” refers to any device or combination of devices capable of storing, accessing and retrieving data, which may include any combination and number of data servers, databases, data storage devices and data storage media, in any standard, distributed or clustered environment. Remote computing resource 1000 can include any appropriate hardware and software for integrating with data store 1003 as needed to execute aspects of one or more applications for the client device 800, the external sources, etc.

Data store 1003 can include several separate data tables, databases or other data storage mechanisms and media for storing data relating to a particular aspect. For example, data store 1003 as illustrated includes digital items (e.g., images) and corresponding metadata (e.g., image segments, popularity, source) about those items. Participant/attendee, host information and/or other information may likewise be stored in the data store.

It should be understood that there can be many other aspects that may be stored in data store 1003, which can be stored in any of the above listed mechanisms as appropriate or in additional mechanisms of any of the data store. Data store 1003 may be operable, through logic associated therewith, to receive instructions from remote computing resource 1000 and obtain, update or otherwise process data in response thereto.

Remote computing resource 1000, in one implementation, is a distributed environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 10. Thus, the depiction in FIG. 10 should be taken as being illustrative in nature and not limiting to the scope of the disclosure.

Aspects of the disclosed system may be implemented as a computer method or as an article of manufacture, such as a memory device or non-transitory computer readable storage medium. The computer readable storage medium may be readable by a computer and may comprise instructions for causing a computer or other device to perform processes described in the present disclosure. The computer readable storage media may be implemented by a volatile computer memory, non-volatile computer memory, hard drive, solid-state memory, flash drive, removable disk, and/or other media. In addition, components of one or more of the modules and engines may be implemented in firmware or hardware.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers, communications, media files, and machine learning should recognize that components and process steps described herein may be interchangeable with other components or steps, or combinations of components or steps, and still achieve the benefits and advantages of the present disclosure. Moreover, it should be apparent to one skilled in the art that the disclosure may be practiced without some, or all of the specific details and steps disclosed herein.

Moreover, with respect to the one or more methods or processes of the present disclosure shown or described herein, including but not limited to the flow charts shown in FIGS. 4-7, orders in which such methods or processes are presented are not intended to be construed as any limitation on the claims, and any number of the method or process steps or boxes described herein can be combined in any order and/or in parallel to implement the methods or processes described herein. In addition, some process steps or boxes may be optional. Also, the drawings herein are not drawn to scale.

Disjunctive language such as the phrase “at least one of X, Y, or Z,” or “at least one of X, Y and Z,” unless specifically stated otherwise, is otherwise understood with the context as used in general to present that an item, term, etc., may be any of X, Y, or Z, or any combination thereof (e.g., X, Y, and/or Z). Thus, such disjunctive language is not generally intended to, and should not, imply that certain implementations require at least one of X, at least one of Y, or at least one of Z to each be present.

Unless otherwise explicitly stated, articles such as “a” or “an” should generally be interpreted to include one or more described items. Accordingly, phrases such as “a device configured to” or “a device operable to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Conditional language, such as, among others, “can,” “could,” “might,” or “may,” unless specifically stated otherwise, or otherwise understood within the context as used, is generally intended to convey in a permissive manner that certain implementations could include, or have the potential to include, but do not mandate or require, certain features, elements and/or steps. In a similar manner, terms such as “include,” “including” and “includes” are generally intended to mean “including, but not limited to.” Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

Although the invention has been described and illustrated with respect to illustrative implementations thereof, the foregoing and various other additions and omissions may be made therein and thereto without departing from the spirit and scope of the present disclosure.

What is claimed is:

1. A computer-implemented method, comprising:
generating, in response to a request to create a livestream interactive experience, a location identifier for accessing a livestream interactive experience session;
obtaining, from a plurality of client devices and via a first interaction with the location identifier, a request for access to the livestream interactive experience session;
in response to obtaining the request for access to the livestream interactive experience session, determining, for each of the plurality of client devices, an access right to the livestream interactive experience session;
initiating the livestream interactive experience session accessible by each of the plurality of client devices;
causing a user interface to be presented on each of the plurality of client devices, the user interface enabling an interactive environment between each of the plurality of client devices and a host client device, wherein the host client device is associated with a host of the livestream interactive experience session;
determining a priority associated with each of a plurality participants associated with each of the plurality of client devices;
receiving, from at least one client device of the plurality of client devices via a second interaction with the user interface, a request for a direct interaction with the host of the livestream interactive experience session;
determining a first client device from the at least one client device in accordance with the priority; and
causing a first representation of a user associated with the first client device to be presented in association with a second representation associated with the host to enable direct interaction between the user associated with the first client device and the host of the host client device.

2. The computer-implemented method of claim 1, wherein:
the interactive environment includes a chat function enabling the plurality of participants and the host to interact via chat messages; and
the chat function includes a chat user interface including an upvote and downvote control, such that the plurality of participants and the host can upvote and downvote the chat messages.

3. The computer-implemented method of claim 2, wherein the priority for each of the plurality of participants is based on at least one of:
an order in which the participant requested direct interaction with the host;
a user history associated with the participant;
upvotes associated with chat messages written by the participant;
downvotes associated with chat messages written by the participant; and
an access level purchased by the participant.

4. The computer-implemented method of claim 1, wherein the user interface presents a first livestream feed of the host and a second livestream feed of the user on the first client device and the host client device.

5. The computer-implemented method of claim 1, wherein the request for access to the livestream interactive experience session is obtained via an interaction with a marketplace listing a plurality of livestream interactive experience sessions.

6. The computer-implemented method of claim 1, wherein a microphone associated with each of the plurality of client devices during an entirety of the livestream interactive experience session and a second microphone associated with the first client device is enabled only during the direct interaction between the user associated with the first client device and the host of the client device.

7. A computing system, comprising:
one or more processors;
a memory storing program instructions that, when executed by the one or more processors, cause the one or more processors to at least:
determine, for each of a plurality of participants in an interactive livestream session, an engagement score associated with each of the plurality of participants;
determine, based at least in part on each engagement score, a priority associated with each of the plurality of participants;
obtain, from a first participant of the plurality of participants, a request for direct interaction with a host of the interactive livestream session; and
cause, based at least in part on the priority associated with the first participant, a first user interface to be presented on a host client device associated with the host of the interactive livestream session and a second user interface to be presented on a client device associated with the first participant so as to initiate a direct interaction between the host and the first participant, wherein the first user interface and the second interface each includes a first livestream feed of the host and a second livestream feed of the first participant.

8. The computing system of claim 7, wherein the engagement score associated with each of the plurality of participants is an aggregation of information including at least one of:
a user history associated with each respective participant;
upvotes associated with chat messages written by each respective participant;
downvotes associated with chat messages written by each respective participant; and
an access level purchased by each respective participant.

9. The computing system of claim 8, wherein the user history includes at least one negative user history.

10. The computing system of claim 8, wherein the user history includes at least one of:
a purchase history associated with each respective participant;
a subscription status associated with each respective participant;
comments associated with each respective participant; or
an attendance history associated with each respective participant.

11. The computing system of claim 7, wherein the first user interface presents the second livestream feed of the first participant more prominently relative to a graphical representation associated with each remaining participant of the plurality of participants.

12. The computing system of claim 7, wherein the second user interface presents the second livestream feed of the first participant more prominently relative to graphical representations associated with each remaining participant of the plurality of participants.

13. The computing system of claim 12, wherein the program instructions, that when executed by the one or more processors, further cause the one or more processors to at least:
generate a third user interface to be presented on a second client device associated with a second participant of the plurality of participants, wherein the third user interface includes the first livestream feed of the host and the second livestream feed of the first participant and the second livestream feed is not presented more prominently relative to the graphical representations associated with each remaining participant of the plurality of participants.

14. The computing system of claim 12, wherein the program instructions, that when executed by the one or more processors, further cause the one or more processors to at least:
generate a third user interface to be presented on a second client device associated with a second participant of the plurality of participants, wherein the third user interface includes the first livestream feed of the host and the second livestream feed of the first participant and the second livestream feed is presented more prominently relative to the graphical representations associated with each remaining participant of the plurality of participants.

15. The computing system of claim 7, wherein the program instructions, that when executed by the one or more processors, further cause the one or more processors to at least:
generate a third user interface presenting links to one or more interactive livestream sessions, wherein the interactive livestream session is included in the one or more interactive livestream sessions.

16. A method comprising:
causing a first user interface to be presented on a first client device associated with a host of an interactive livestream session, the first user interface including a livestream feed captured by a first recording device of the first client device and a plurality of visual representations associated with each of a plurality of participants attending the interactive livestream session;
determining a priority associated with each of the plurality of participants;
determining, based at least in part on the priority, a participant from the plurality of participants for a direct interaction with the host of the interactive livestream session; and
causing a second user interface to be presented on the first client device, the second user interface including a second livestream feed captured by a second recording device of a second client device associated with the participant, wherein the second livestream feed is presented more prominently relative to the plurality of visual representations associated with a remaining participant from the plurality of participants attending the interactive livestream session.

17. The method of claim 16, wherein the plurality of participants are presented in the first user interface in accordance with the priorities associated with each of the plurality of participants.

18. The method of claim 16, wherein, prior to causing a second user interface to be presented, the visual representation associated with the participant is presented more prominently relative to the plurality of visual representations associated with the remaining participants from the plurality of participants attending the interactive livestream session.

19. The method of claim 16, wherein the priority associated with each of the plurality of participants is an aggregation of information including at least one of:
a user history associated with each respective participant;
upvotes associated with chat messages written by each respective participant;
downvotes associated with chat messages written by each respective participant; and
an access level purchased by each respective participant.

20. The method of claim 16, further comprising:
analyzing a dialogue associated with the interactive livestream session to determine a topic;
determining, using a recommendation service, at least one content item associated with the topic; and
presenting the at least one content item on the second client device.
